(19) United States
(12) Patent Application Publication
(10) Pub. No.: US 2016/0185456 A1
(43) Pub. Date: Jun. 30, 2016

(54) POWER AND DATA TRANSMISSION OVER THIN CONDUCTOR FOR UNMANNED AERIAL VEHICLE

(71) Applicant: Hoverfly Technologies, Inc., Oviedo, FL (US)

(72) Inventors: Alfred D. Ducharme, Oviedo, FL (US); Stephen Quigley, East Hampstead, NH (US)

(73) Assignee: Hoverfly Technologies, Inc., Oviedo, FL (US)

(21) Appl. No.: 14/247,974

(22) Filed: Apr. 8, 2014

Related U.S. Application Data
(60) Provisional application No. 61/809,600, filed on Apr. 8, 2013.

(51) Int. Cl. B64C 39/02; H02M 3/02; H02M 5/40; H02M 7/42

(52) U.S. Cl. CPC B64C 39/022; H02M 7/42; H02M 3/02; H02M 5/40; B64C 39/024; B64C 2201/108

(57) ABSTRACT

A system for tethered unmanned aerial vehicle having an unmanned aerial vehicle platform capable of flight. At least one propeller is mounted on the platform. A ground power system includes a low voltage direct current power supply for creating a low voltage direct current power signal and converting the low voltage direct current power signal to a higher voltage power signal. A tether physically and operatively couples the ground power system to the unmanned aerial vehicle platform and transmits the higher voltage power signals in alternating current voltage power signal to the unmanned aerial vehicle platform for powering the at least one propeller.

### CROSS REFERENCE TO RELATED APPLICATION

This application claims the benefit of U.S. Provisional Patent Application No. 61/809,600, filed Apr. 8, 2013, the contents of which are herein incorporated.

### BACKGROUND OF THE INVENTION

The present invention relates generally to a powered flight platform device, and more particularly to an apparatus and method for tethered high altitude sustained flight, including a camera mounted thereon.

An Unmanned Aerial Vehicle (UAV) is defined in this application as a free-floating (untethered) aerial platform suspended by a plurality (more than one) of motorized propellers attached rigidly to a solid mechanical framework. In the preferred embodiment, the number of motorized propellers would be four but the disclosed invention is not limited by this number and as few as two could be utilized. In addition, there is no upper limit to the number of motors that could be controlled by this invention.

Electrically powered UAVs typically carry on-board battery sources for powering the motors to attain flight and hover. An example battery type is lithium polymer and has a capacity of 5 Amp-hours. These batteries are depleted during flight and as a result the time the UAV can stay aloft is limited by the capacity of the battery. Modern battery technology can only provide on average a 10 to 30 minute flight time.

There are many applications of UAVs, such as persistent surveillance by law enforcement, when landing and charging or replacing batteries is not desired.

The power required by a UAV for flight and other on-board electronics is typically between 500-5000 watts or greater. The motors and other electronics typically operate using Direct Current (DC) at a voltage between 12 to 28 volts. In order to enable power transmission at 500 watts at 12 volts DC would require a current of approximately 42 amps. According to the American Wire Gauge standards a pair of 5 AWG wire weighing a total of 200 lbs/1000 ft would be required. A typical UAV would not be able to lift the wire needed to power it more than a few feet off of the ground.

Tethered aerial vehicles are known in the art and rely upon balloon flight and suffer from altitude limitations. Additionally, hazardous gases such as helium were required along with a sizeable staff and a dedicated base facility to maintain the balloon. To overcome these shortcomings, a type of hybrid in which a powered UAV tethered to a base station as known from U.S. Published Application No. 2012/0112008 provided power along the tether to the UAV which has a lift mechanism such as a wing providing substantially unlimited flight time. The propeller is used to pull the wing through air like a plane, not to directly lift the platform. These have been satisfactory, however they make use of a high voltage, high powered generator of up to ten kilowatts requiring large power source, and a heavy gauge tether in order to accommodate the high voltage. This adds weight to the overall system as the tether is in effect carried by the UAV platform, and also requires a large power plant. Again, the UAV which utilizes the propellers to lift rather than provide movement for wings, would struggle to raise the platform and tether without the large power source.

Accordingly, a tethered UAV which overcomes the shortcomings of the prior art is desired.

### SUMMARY OF THE INVENTION

A tethered unmanned aerial vehicle system includes an aerial platform suspended by one or more motorized propellers. A ground power source includes a direct current low voltage source providing an input to an inverter, which in turn provides an input to a step down transformer. An electrically conductive tether couples the power source to the platform for powering the one or more motorized propellers. A rectifier receives the alternating current and provides a DC input to a DC to DC step down converter for converting the current to a usable DC power supply on the platform.

### BRIEF DESCRIPTION OF THE DRAWINGS

For a fuller understanding of the invention, reference is had to the following description taken in connection with the accompanying drawings in which;

FIG. 1 is a schematic diagram of the tethered unmanned aerial vehicle in accordance with the invention; and

FIG. 2 is a schematic diagram of the tethered unmanned aerial vehicle utilizing alternating current in accordance with another embodiment of the invention.

### DETAILED DESCRIPTION OF THE PREFERRED EMBODIMENT

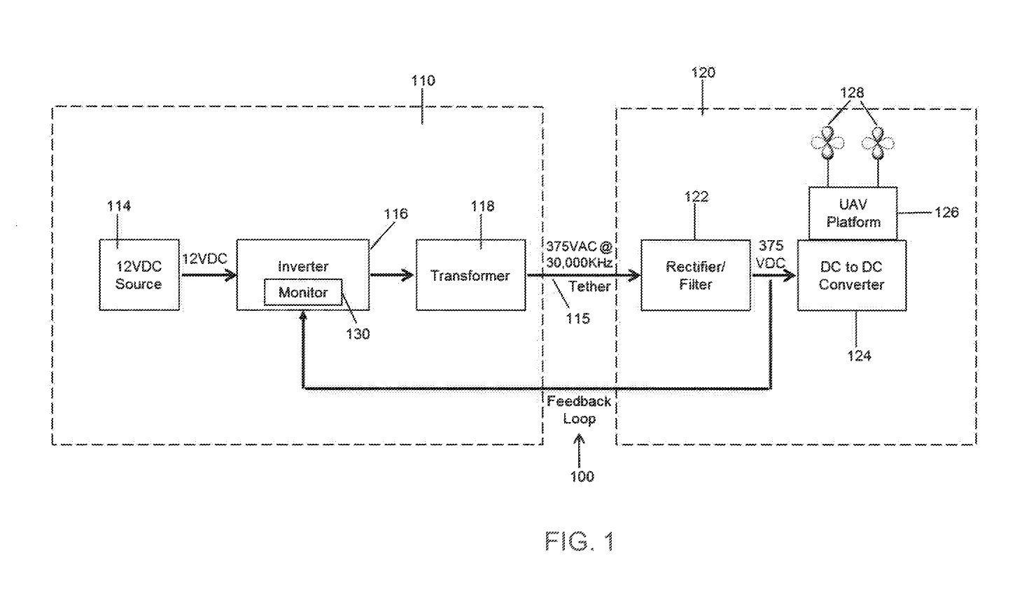

Reference is made to FIG. 1 in which a system, generally indicated as 100, for a tethered unmanned aerial vehicle constructed in accordance with the invention is provided. System 100 includes a power source 110 and an unmanned aerial vehicle (UAV) platform 120. Power source 110 is electrically coupled to the unmanned aerial vehicle 120 by a tether 115.

In a preferred non-limiting embodiment, power source 110 includes a low voltage direct current (DC) power source 114. In a preferred non-limiting embodiment, low voltage shall mean 28 volts or less, and in the preferred embodiment is 12 volts. Power source 114 outputs a low volt DC power signal to an inverter 116.

Inverter 116 converts the low voltage DC power signal to an alternating current power signal. In a preferred embodiment, inverter 116 operating with transformer 118 converts the low voltage DC power signal to a stepped up higher voltage high frequency alternating current power signal such as 375 volts at 30,000 Hz by way of non-limiting example

Tether 115 physically connects UAV 120 to a base station. However, it also includes a conductor which electrically connects power supply 110 to UAV 120. In a preferred embodiment, tether 115 is a relatively low gauge (20-30 AWG) wire. As such, tether 115 can be made lightweight relative to the lifting capacity of motorized propellers 128 which directly or indirectly affixed to UAV platform set. UAV platform 126 includes the motor for driving propellers 128, as well as sensors, cameras and/or communication equipment, or other circuitry for a known purpose as known in the art.

Platform 120 includes a rectifier 122 for receiving the alternating current power signal and conditioning the power signal back to a DC power signal. The DC signal is then lowered in voltage to the voltage required to power the motorized propeller by a DC to DC step down converter 124 to drive motorized propellers 128 mounted on platform 120 to lift platform 120. Propellers 128 are oriented substantially in parallel with the remainder of platform 120 to provide lift to platform 120, as known in the art, similar to a helicopter.

In a preferred embodiment, rectifier 122 and DC to DC converter 124 are mounted on the UAV platform 120. However, given the size of circuitry as known in the art, some of the circuitry may actually be incorporated into tether 115.

In the preferred embodiment of the disclosed invention the data processing and control of a UAV will be achieved using a pair of conductors with a American Wire Gauge value of 22-30 AWG; 26 AWG in a preferred but non-limiting embodiment. In addition, an additional pair of similar gauge conductors can be added to carry data to and from the UAV. Power supply 110 on the ground will continually supply power to the UAV 120 so that flight of an indefinite time can be attained.

In the disclosed invention, Alternating Current (AC) is used at high frequency to transmit the power to UAV 120 where it is inverted back to the needed DC power which enables the use of low gauge wire along or as, tether 115. In a preferred non-limiting embodiment of system 100, as shown in FIG. 1, a ground power supply Inverter 116 utilizes 12VDC. In a preferred but non-limiting embodiment, inverter 116 and transformer 118 convert this power to 375 VAC at 30,000 Hz alternating frequency. This power is transmitted to the UAV platform 120 using tether 115 which includes a pair of, in a preferred non-limiting embodiment, 26 AWG conductors. At the UAV 120 the 375VAC is converted back to 12VDC using a rectifier circuit 122 and in a preferred embodiment, DC-to-DC converter module 124. One such DC to DC converter is known from the Vicor Maxi family 375V inverter module.

Since the load or power requirement of the UAV changes over time and from take-off, ascent, hover, and descent, a feedback loop is utilized to control the power input to rectifier 122. Data regarding current power demand originates at UAV 120 and travels back to the ground power supply 110 over an additional set of conductors in tether 115 or a wireless connection. A voltage monitoring device 130 is used to collect data on the voltage level at the input to inverter 116. This data is continually monitored and used to turn power supply 110 on and off in order to regulate the power transmitted to the UAV 110.

Transformer 118 is used to step up the voltage level from the AC output of the rectifier 116 to the required voltage, such as 375VAC in one preferred but non-limiting embodiment, used by tether 115. A unique part of this invention is that the transformer 118 can be used in the mechanics of the recoiling system used to spool tether 115 as the aircraft ascends and descends.

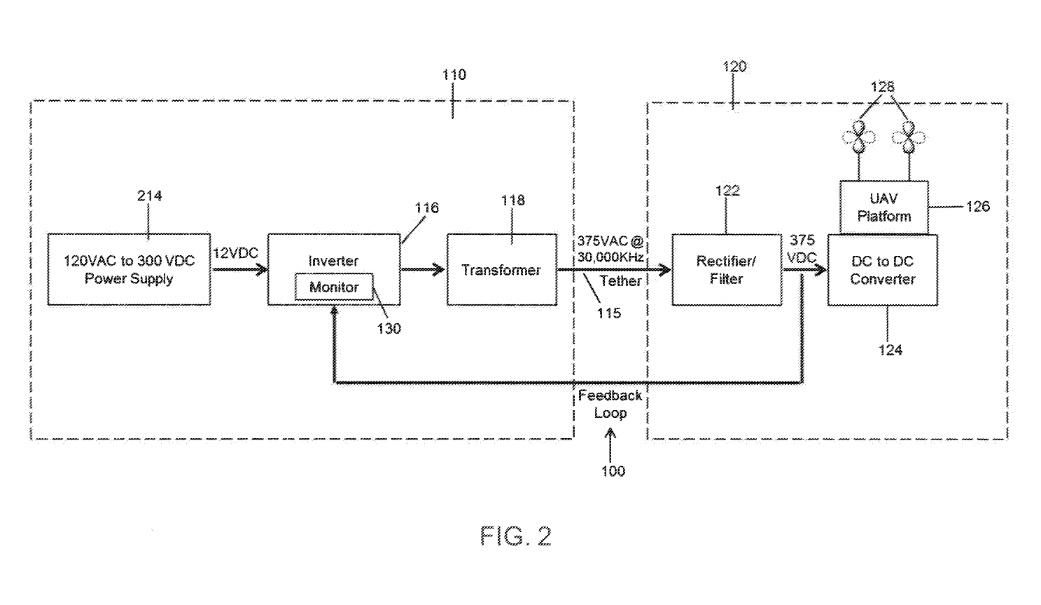

As seen in FIG. 2, in one non-limiting exemplary embodiment, a DC power source 214 may be an AC to DC rectifier and converter making use of normal outlet alternating current (120V AC) power by way of example to be output as a higher voltage DC power signal; such as 300 volts DC in a non-limiting exemplary embodiment. Like numerals are utilized to identify like structure. As with the embodiment of FIG. 1, even though power source 214 is a plug-in device making use of alternating power, it converts the alternating current power to a direct current power of 12 volts in this example. This is input to inverter 16 and the system behaves and operates as discussed above. In this way, when near a conventional electrical outlet or any other type of electricity source, system 100 may be used without fear of draining a battery.

A transformer transfers power between two coils in close proximity using inductive coupling. Alternating current in the primary winding creates a varying magnetic flux in a secondary winding. This in turn creates an alternating current in the second winding. A recoiling system can be fabricated with the primary winding in a static position and the secondary winding in the rotating portion of the recoil spool. This eliminates the need to use a mechanical slip ring and improves overall efficiency and complexity of the mechanics of the recoil system.

The proposed invention has been realized and demonstrated to achieve unlimited flight of a UAV requiring 500 watts of power.

What is claimed as new and desired to be protected by Letters Patent is:

1. A system for tethered unmanned aerial vehicle flight comprising;
an unmanned aerial vehicle platform capable of flight;
at least one propeller mounted on the unmanned aerial vehicle platform for lifting the unmanned aerial vehicle platform;
a ground power system and a tether system, the tether system physically and operatively coupling the unmanned aerial vehicle platform to the ground power system, the ground power system including a low voltage direct current power supply for creating a low voltage direct current power signal, and converting the low voltage direct current power signal to a higher voltage power signal than the low voltage direct current power signal;
a tether transmitting the higher voltage power signal as an alternating current voltage power signal to the unmanned aerial vehicle platform for powering the at least one propeller.

2. The system of claim 1, further comprising an inverter in the ground power system for receiving the low voltage direct current power signal from the low voltage direct current power supply, and converting the low voltage direct current power signal to the alternating current voltage power signal.

3. The system of claim 2, further comprising a step-up transformer for receiving the alternating current voltage power signal from the inverter and increasing the voltage of the alternating current voltage power signal to the higher voltage power signal.

4. The system of claim 1, further comprising a rectifier mounted on the unmanned aerial vehicle platform, and electronically coupled to the transformer, the rectifier receiving the alternating current voltage power signal and conditioning the alternating current voltage power signal to a direct current power signal.

5. The system of claim 4, further comprising a direct current step-down converter for receiving the direct current power signal from the rectifier and reducing the voltage of the direct current power signal to provide an output voltage for use by the at least one propeller.

6. The system of claim 1, further comprising a voltage monitor for monitoring a voltage level at the input to the inverter and the load of the unmanned aerial vehicle, and providing an output, the power supply being turned on and off as a function of the output.

7. A system for tethered unmanned aerial vehicle flight comprising:
an unmanned aerial vehicle platform capable of flight;
at least one propeller mounted on the unmanned aerial vehicle platform for lifting the unmanned aerial vehicle platform;
a ground power system and a tether system, the tether system physically and operatively coupling the unmanned aerial vehicle platform to the ground power system, the ground power system including a low voltage alternating current power supply for creating an alternating current power signal, and converting the alternating current power signal to a lower voltage direct current power signal, having a voltage lower than the voltage of the alternating current power signal; and then converting the lower voltage direct power signal to a higher voltage power signal than the lower voltage power signal; and
a tether transmitting the higher voltage power signal as an alternating current voltage power signal to the unmanned aerial vehicle platform for powering the at least one propeller.

8. The system of claim 1, further comprising a step-up transformer for receiving the low voltage direct current power signal from the low voltage direct current power supply, and converting the low voltage direct current power signal to the alternating current voltage power signal.

9. The system of claim 7, further comprising a step-up transformer for receiving the voltage alternating current voltage power signal and increasing the low voltage of the alternating current voltage power signal to the higher voltage power signal, of the alternating current voltage power signal.

10. The system of claim 7, further comprising a rectifier mounted on the unmanned aerial vehicle platform, and electronically coupled to the transformer and receiving the alternating current power signal and conditioning the alternating current voltage power signal to a direct current voltage power signal.

11. The system of claim 10, further comprising the direct current step-down converter for receiving the conditioned direct current power signal from the rectifier and reducing the voltage of the conditioned direct current power signal to provide an output voltage for use by the at least one propeller.

12. The system of claim 7, further comprising a voltage monitor for monitoring a voltage level at the input to the inverter and the load of the unmanned aerial vehicle and providing an output, the power supply being turned on and off as a function of the output.
